(19) United States
(12) Patent Application Publication
(10) Pub. No.: US 2023/0030926 A1
(43) Pub. Date: Feb. 2, 2023

(54) PET CHEW CONTAINING MISCANTHUS GRASS

(71) Applicant: T.F.H. PUBLICATIONS, INC., Neptune City, NJ (US)

(72) Inventors: Glen S. AXELROD, Colts Neck, NJ (US); Ajay GAJRIA, Monmouth Junction, NJ (US); Mary Louise FETTER, Ocean, NJ (US)

(21) Appl. No.: 17/815,783

(22) Filed: Jul. 28, 2022

Related U.S. Application Data
(60) Provisional application No. 63/203,682, filed on Jul. 28, 2021.

(51) Int. Cl. A23K 10/30; A23K 20/105; A23K 40/20; A23K 40/25; A23K 50/40

(52) U.S. Cl. CPC A23K 10/30; A23K 20/105; A23K 40/20; A23K 40/25; A23K 50/40

(57) ABSTRACT

A method of forming a pet chew, comprising supplying Miscanthus grass; supplying at least one polymer; combining the Miscanthus grass and the at least one polymer to form a polymeric composition containing the Miscanthus grass; and forming the pet chew of the polymeric composition containing the Miscanthus grass. A pet chew containing Miscanthus grass is also disclosed.

### CROSS-REFERENCE TO RELATED APPLICATIONS

This U.S. non-provisional patent application claims the benefit of the filing date of U.S. provisional patent application Ser. No. 63/203,682, filed Jul. 28, 2021, the entire disclosure of which is incorporated herein by reference.

### FIELD

The present disclosure relates to animal products, and more particularly pet chew products.

### BACKGROUND

Miscanthus is a genus of plants in the grass family, Poaceae. Miscanthus is cultivated as crop from the dried canes of Miscanthus giganteus, a grass grown for its relatively high fiber content. Miscanthus giganteus is a sterile hybrid of the species Miscanthus sinensis and Miscanthus sacchariflorus. Miscanthus giganteus is known as a perennial grass with bamboo-like stems that can grow to heights of 3-4 meters in one season (from the third season onward). It reportedly has been used as a biofuel given its relatively high calorific value and can be processed into pellets. As a sustainable material, there presents an on-going need to identify potential applications for Miscanthus grass to replace raw materials in a variety of industries. That is, while it has been identified as a promising energy crop, commercialization into other applications have become a recent focus.

### SUMMARY

A pet chew, comprising a polymeric composition comprising at least one polymer and Miscanthus grass; and the polymeric composition molded in a form of the pet chew.

A method of forming a pet chew, comprising supplying Miscanthus grass; supplying at least one polymer; combining the Miscanthus grass and the at least one polymer to form a polymeric composition containing the Miscanthus grass; and forming the pet chew of the polymeric composition containing the Miscanthus grass.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 is a perspective view of a pet chew containing Miscanthus grass;

FIG. 2 is a perspective view of another pet chew containing Miscanthus grass; and

FIG. 3 is a perspective view of another pet chew containing Miscanthus grass.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting.

The present disclosure is directed to pet chews including Miscanthus grass, and methods of providing pet chews including Miscanthus grass. More particularly, the present disclosure is directed at the incorporation of Miscanthus grass as an additive to a variety of polymer resins to provide a polymeric composition that is particularly molded into the form of a pet chew. The Miscanthus grass may more particularly be Miscanthus giganteus.

The pet chews are formed of a polymeric composition, with the Miscanthus grass incorporated or otherwise disposed with the polymeric composition. In some embodiments, the Miscanthus grass may be incorporated or otherwise disposed (e.g. randomly) within the polymeric composition. In other embodiments, the Miscanthus grass may be incorporated or otherwise disposed at only a particular location of the pet chews, such as disposed (e.g. randomly) on the outer surface of the polymeric composition. Accordingly, the Miscanthus grass may be incorporated or otherwise disposed with the polymeric composition before, after or while forming the polymeric composition into the pet chew.

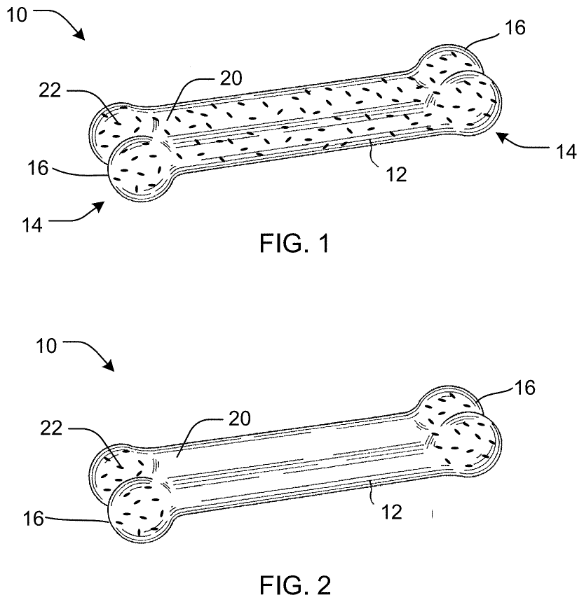

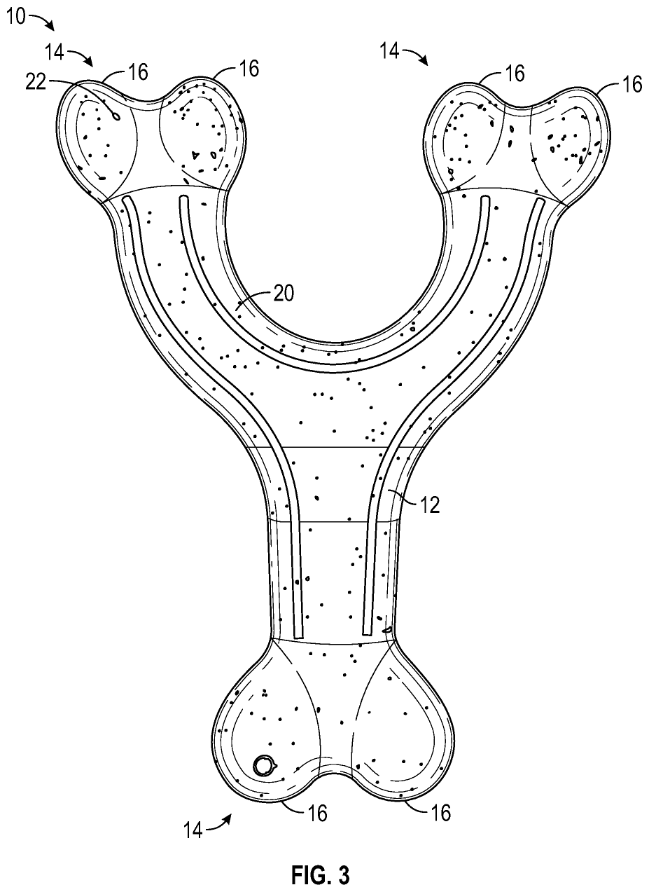

Examples of a non-limiting embodiments of pet chews contemplated herein are shown in FIGS. 1-3. The pet chew 10 may take on a number of forms. In FIG. 1. the pet chew 10 is in a form of a bone which comprises an elongated (medial) shaft region 12 disposed between bulbous end regions 14, which may be in the form of a plurality of condyles/knuckles 16. As shown in FIG. 1, the Miscanthus grass particles 22 may be disposed randomly on the surface of the pet chew 10 and/or randomly within the polymer resin/polymeric composition 20 through the volume of the pet chew 10 (i.e. below the surface). As shown in FIG. 2, the Miscanthus grass particles 22 may be provided at selected locations, such as only on the surface of the pet chew 10/polymeric composition 20 and only on the bulbous end regions 14. As shown in FIG. 3, the Miscanthus grass particles 22, are disposed in similar fashion to FIG. 1, however the pet chew 10 is Y-shaped and has three bulbous end regions 14 rather than two bulbous end regions 14.

Polymer resins particularly include biocompatible polymer resins, as well as synthetic polymer resins, natural or naturally derived polymer resins and edible polymer resins, which may be formed using a number of forming processes. Biocompatible polymer resin may include synthetic polymer resins, natural or naturally derived polymer resins and edible polymer resins.

Biocompatible resins may include resins that do not exhibit toxic and/or injurious effects on biological systems, such as the digestive track of a pet. Such biocompatible resins may be edible, but may or may not be digestible.

Synthetic polymer resins may particularly include thermoplastic polymer resins, including polyamides (nylons), polyesters, polyurethanes, thermoplastic elastomers (such as polyester thermoplastic elastomers or polyurethane elastomers), polyethylene, polypropylene, ABS, polystyrene, polyacrylates and polycarbonate. Edible synthetic polymer resin may include ester resins.

The Miscanthus grass may also serve as an additive in a variety of synthetic thermoset polymer resins, including polyurethanes, epoxy resins, polyester resins, vinyl ester resins, and vulcanized rubber (cross-linked polyisoprene).

Natural or naturally derived polymer resins, which may include edible polymer resins, and which may be derived from plants, include starch based compositions. Starch may specifically include, e.g., starch sourced from corn, wheat and/or potatoes. Other examples of natural or naturally derived polymer resins include gluten, casein, gelatin and collagen (rawhide).

One or more of the foregoing polymer resins may be used to provide the polymeric composition of the pet chew, which includes the Miscanthus grass, and may include other optional additives as described below.

In particular, for example, any of the above referenced polymer resins are combined with 0.1% by weight to 10.0% by weight of the Miscanthus grass. In other words, the polymeric composition of the chew may particularly comprise 0.1% by weight to 10.0% by weight of the Miscanthus grass, and 90% by weight to 99.9% by weight of one or more of the polymer resins.

More particularly, the polymeric composition may comprise 0.1% by weight to 5.0% by weight of Miscanthus grass, and even more particularly 0.1% by weight to 2.5% by weight of Miscanthus grass, and 0.1% by weight to 1.0% by weight of Miscanthus grass.

Alternatively, the Miscanthus grass may be used in greater percentages if a greater degree of fiber is desirable to be provided to the pet. For example, the polymeric composition may comprise 0.1% by weight to 15% by weight of Miscanthus grass, or moreover 0.1% by weight to 20% by weight of Miscanthus grass, or moreover 0.1% by weight to 25% by weight of Miscanthus grass. In such situation, the at least one polymer resin may comprise 85% to 99.9% of the polymeric composition, 80% to 99.9% of the polymeric composition, or 75% to 99.9% of the polymeric composition, respectively, which may be reduced by the percentage of the other additives, if any, respectively.

The Miscanthus grass may particularly be combined with the polymer resin(s) when in a discrete particle form. As such, the polymer resin(s) may be understood to provide a continuous phase while the Miscanthus grass particles provide a discontinuous phase dispersed within the polymer resin(s). The remainder of the polymeric composition may comprise one or more of the polymer resins.

The Miscanthus grass particles may particularly be in (oblong) pellet form where the Miscanthus grass pellet has a length of 0.25″ (inch) to 1.0″ (inch) and with a diameter of 0.1″ (inch) to 0.33″ (inch). Alternatively, the Miscanthus grass particles may be granulated and further reduced to a diameter of less than 0.1″ (inch), such as in the range of 250 microns to less than 0.1″ (inch).

Optionally the polymeric composition may include other additives, such as a flavoring, attractant, and/or colorant additive. The additives may also include one or more antioxidants, minerals or vitamins. The flavoring, attractant, colorant, antioxidant, mineral or vitamin additive, may each be present at a level of 0.1% by weight to 2.5% by weight of the polymeric composition.

By way of example, one synthetic thermoplastic formulation may more specifically include 99.5% by weight of polyamide (nylon), 0.2% by weight of Miscanthus grass and 0.3% by weight of bacon and/or bacon flavoring to provide a pet chew with the foregoing polymeric composition. In another example, the thermoplastic formulation may include 99.0% by weight nylon, 0.3% by weight Miscanthus grass and 0.7% by weight of chicken and/or chicken type flavoring to provide a pet chew with the foregoing composition.

The thermoplastic and/or thermoset and/or edible polymer resin(s) noted herein, along with the Miscanthus grass and other optional additives, is formed into the desired shape of a pet chew, which may also be referred to as a pet chew product or an article. Such may be accomplished by a variety of techniques, including injection molding, extrusion, or compression molding.

More particularly, the thermoplastic or edible polymer resin(s) may be heated to a temperature wherein such is softened and capable of being formed into a desired shape. For example, the Miscanthus grass particles may randomly dispersed in the polymer resin(s) by melting the polymer resin(s) and mixing the Miscanthus grass particles with the melted polymer resin(s).

In the case of thermoset polymer resins, a thermoset resin precursors may combined with the randomly dispersed Miscanthus grass particles therein, as well as optional additives, and then introduced into a mold wherein the resin precursors react to form a cross-linked polymer network with the mold having a cavity of a shape of the desired pet chew.

It should be noted that the Miscanthus grass particles herein has been observed to form what may be described as a random speckled pattern in the polymer composition subsequent to molding. For example, in the case of molding a polymer composition with polyamide resin and 0.1% by weigh to 1.0% by weight of Miscanthus grass, one observes the formation of a molded pet chew where the Miscanthus grass particles appears with a random speckled pattern, namely a distribution of relatively small spots or patches of relatively darker color as compared to the polyamide continuous phase. The spots have a size in the range of 0.1 mm to 10.0 mm (longest linear dimension), or 0.1 mm to 5.0 mm, or 0.1 mm to 2.5 mm. That is, upon heating and softening the polyamide resin along with the Miscanthus grass and optional flavoring, attractant, and/or colorant additive, the Miscanthus grass particles appear to phase separate into relatively dark color spots within the polyamide continuous phase.

Expanding upon the above, the pet chew formed herein with the Miscanthus grass particles are such that Miscanthus grass particles, in the molded product, is in the form of a visibly distinct spot or patch from the polymer resin. Among other things, this confirms to the consumer that the subject pet chew was formed from a polymer resin and Miscanthus grass, where the Miscanthus grass is a renewable resource. In addition, the Miscanthus grass, presents a source of fiber and is contemplated to enhance the hardness of the pet chew formed and thereby increase chewing time.

As set forth above, the natural or naturally derived polymer resins, which may include edible polymer resins, may be derived from plants, include starch compositions. The starch may include amylose and/or amylopectin and may be extracted from plants, including but not limited to potatoes, rice, tapioca, corn and cereals such as rye, wheat, and oats. The starch may also be extracted from fruits, nuts and rhizomes, or arrowroot, guar gum, locust bean, arracacha, buckwheat, banana, barley, cassava, konjac, kudzu, oca, sago, sorghum, sweet potato, taro, yams, fava beans, lentils and peas. The starch may be present between about 30-99% including all increments and values therebetween such as levels above about 50%, 85%, etc.

The starch employed herein may be raw starch, which may be understood as starch that has not seen a prior thermal molding history, such as extrusion or other type of melt processing step. The raw starch itself may also be native, which may be understood as unmodified starch recovered in the original form by extraction and not physically or chemically modified. The raw starch may also be in powder form of varying particle size, which may be understood as milled and/or pre-sifted. It should be understood that the raw starch may also have varying degrees moisture present.

The polymeric composition may also include water. The water may be introduced into the polymeric composition between about 1-40% by weight of the polymeric composition and any increment or value therebetween, including 4%, 20-40%, 10-20%, etc. After the pet chew has been formed, the water may be present between 1-20% by weight of the polymeric composition including all increments or values therebetween, such as, below 20%, 4%, 5-10%, etc.

In one embodiment of forming a pet chew, the Miscanthus grass particles may be incorporated into a polymer resin/polymer composition comprising starch prior to molding. The process may begin with adjusting the water content of the starch by adding water to the starch, which may be present in the range of 20% to 40% by weight with respect to that of the starch, including all values and ranges therein, and mixing of the water with the starch. The Miscanthus grass particles may also be added to the starch and mixed therein. The mixing of the starch, water and/or Miscanthus grass particles may be preformed in a preconditioner or in a plasticating device, as discussed further below.

This may then be followed by a reduction of the water content of the starch mixture. This reduction may be facilitated by placement of the starch mixture into a plasticating device, such as a single screw extruder, twin screw extruder, reciprocating screw injection molding machine, etc. Plastication may be understood as the input of heat, mechanical action or both, into a material, which may result in a change in the material's viscosity. In this embodiment, a twin screw or single screw extruder may be utilized at sufficient temperature to melt and plasticate the starch. In the context of the present disclosure, where the water level charged in the extruder is preferably lowered during the course of extrusion, an extruder that is configured for venting may be employed, wherein such venting lowers the water level to a desired level. To facilitate such water level change, it may be particularly useful to apply a light vacuum to the extruder barrel at the vent port, to thereby provide a more efficient removal of water from the extrudate therein.

The resulting products of extrusion may be conveniently formed in various shapes. For example, the resulting products may be formed into the shape of beads/pellets, the size of which can be made to vary in accordance with standard pelletizing equipment. Or, the resulting products of extrusion may be formed into sheets, which may then be formed into rolls, cut or punched into a desired shape.

Once extruded bead is produced, the water level of the bead exiting the extruder is less than the water level of the starch/water mixture entering the extruder. In the context of the present disclosure, it has been appreciated that by starting at the starch/water levels herein, one may effectively insure that one will ultimately proceed to injection molding, if so desired at an adequate water level to provide for a stable melt (non-degrading) and injection mold a quality starch product with improved performance characteristics.

Subsequent to recovery of the starch/water extrudate, optionally, the extrudate may be placed into a dryer at various periods of time, from 1 hour to 96 hours, including all values and ranges therein, wherein the water level of the extrudate is lowered an additional amount depending upon dryer conditions. Preferably, the water level of the starch/water extrudate may be lowered within the range of about 15% to 20% by weight of the weight of the product, at which point the extrudate is in condition for injection molding. Further drying may occur, or drying at higher temperatures to produce a final product having a moisture level in the range of 5% to 20% by weight of the weight product, including all values and ranges therein.

In some embodiments, the extruded products (the beads or pellets) may then be injection molded. In the step of injection molding, preferably, the injection molding technique is similarly configured to reduce moisture content once again, to a final level that is at or below about 20% by weight of the starch material. However, in preferred embodiment, the final level of water in the molded product is between about 5% to 20% by weight of the molded product, in a more preferable embodiment the water level of the molded product is set to about 10-15% by weight, and in a most preferred embodiment, the water level of the molded product is set to about 11-14%, or 11-13% by weight. It has been found, therefore, that by sequencing the loss of water, from extrusion, to injection molding, one may achieve outstanding quality for the various shaped products produced in accordance with such step-down in moisture levels through-out the melt processing history disclosed herein.

In that regard, the initial zone or zones of the injection molding machine may be cooled proximate the hopper feed section to improve the quality of the injection molded parts produced herein. Those skilled in the art will appreciate that an injection molding machine may typically contain a hopper feed section, a barrel and an output nozzle, including a plurality of heating zones in the barrel extending from the hopper section to the nozzle. The temperature in the first zone adjacent the hopper may be heated at a temperature of less than about 150° F. More preferably, the first zone adjacent the hopper may be set in the range of about 45-150° F. In an even more preferred embodiment, i.e., that situation wherein there is a first zone adjacent the hopper, and a second zone adjacent the first zone, the temperatures of the first zone may be set to about 45-70° F., and the second zone may be set to about 70-150° F. These temperatures may be achieved by the use of cooling cools placed about the barrel of the injection molding machine, said cooling cools comprising copper cooling cools with circulating water.

In a particularly preferred embodiment, the following temperature profile may be applied to a standard injection molding machine: Zone 4 (closest to hopper=45-70°) F.; Zone 3=70-150° F.; Zone 2=150-300° F.; Zone 1=275-375° F., Nozzle=275-390° F. In addition, bushing (inside the mold) is preferably set at about 325-425° F. The mold temperature may be set at 35-65° F.

Any additional additives may be added during the preconditioning process, extrusion process or the injection molding process. In some embodiments, depending on the sensitivity or mixability of the additives, different additives may be added at different steps during the process or may be added multiple times during a process.

In other embodiments, the starch, water, Miscanthus grass particles and any additional additives may be directly injection molded. The term “direct” as used herein with respect to injection molding refers to the molding of starch without exposing the starch to prior thermal molding histories before injection molding. However, the starch herein may, e.g., be heated for drying purposes, which would not amount to a prior thermal molding history. Accordingly, in such an embodiment, the ingredients/components of the polymeric (starch) composition may be introduced directly into the barrel of an injection molding machine through a hopper or other feeding device. Water may be added to the starch in the range of 20% by weight to 40% by weight, including all values and ranges therein. Various feeding devices for introducing the additives into the injection molding barrel may be contemplated including loss-in weight gravimetric blenders/feeders, auger feeders, venturi loaders, etc. Those skilled in the art will appreciate that an injection molding machine may typically include a barrel including a feed section, a screw and an output nozzle. The barrel may include a plurality of temperature control zones in the barrel extending from the feed section to the nozzle. The injection molding machine may include a mold having one or more cavities. The molding machine may also be vented, including a vented barrel and/or a vented mold.

The temperature adjustment may vary for each zone. For example, in one exemplary embodiment, the molding machine barrel may include 4 zones, zone 1 being the closest to the feed section and zone 4 being the closest to the nozzle. Zone 1 may be set to less than about 150° F., including any increment or value between about 35 to 150° F. including between about 46 to 150° F., 46 to 70° F., etc. Similarly zone 2 may be set between about 70 to 150° F. including any increment or value therebetween, zone 3 between about 50 to 300° F. including any increment or value therebetween, and zone 4 between about 200 to 375° F. including any increment or value therebetween. The nozzle may be set between about 250 to 390° F. including any increment or value therebetween. The bushing inside of the mold may be set between about 250 to 425° F. including any increment or value therebetween and the mold may also be set between about 35 to 65° F. including any increment or value therebetween.

Once introduced into the barrel of the molding machine the ingredients/components may be blended as the screw conveys the polymeric composition towards the mold where the polymeric composition may be formed. The mold may cool the polymeric composition. Once molded, and venting takes place, the polymeric composition may include water between about 1-20% by weight of the polymeric composition/product, including all increments and values therebetween such as 10%, 15%, etc. The polymeric composition may be molded into any form capable of being produced in an injection molding cavity.

In yet another embodiment, the polymeric composition may be formulated and plasticated (either in an extruder or an injection molding machine) without adding the Miscanthus grass particles to the polymeric composition. The polymeric composition may then be formed into a pet chew, and the Miscanthus grass applied to the outer surface of the pet chew.

After formation of the polymeric composition (either with or without adding the Miscanthus grass particles), the composition may be relatively sticky and exhibit a moisture content in the range of 5% by weight of the product to 20% by weight of the product, including all values and ranges therein. In addition, the polymeric composition may exhibit a temperature that is 10° F. to 80° F. above ambient temperature or 70° F., including all values and ranges therein. The Miscanthus grass particles may be applied to the relatively tacky surfaces of the pet chew (e.g. sprinkled), and adhere to the pet chew. As the pet chew continues to cool and/or the moisture content is reduced, the Miscanthus grass particles may remain on the surface of the pet chew.

In further embodiments, an adhesive composition may be applied to the surface of the pet chew prior to applying the Miscanthus grass particles. The adhesive composition may include, for example, pasteurized egg whites, albumin, an aqueous solution of tylose powder, or other edible adhesives. The adhesive composition may be applied to the surfaces upon which the Miscanthus grass particles will be applied. After applying the adhesive, the Miscanthus grass particles may be applied to the surface of the polymeric composition and the edible adhesive may be dried.

The pet chews may exhibit a sufficient hardness and ductility to be repeatedly mechanically abraded by a pet's teeth before the structural integrity of the chew is reduced and breaks into one or more pieces. In a preferred embodiment, the hardness of the pet chews, as measured by ASTM D2240-05 (2010), may be in the range of Shore 70A to Shore 80D, including all values and whole number ranges therein, including e.g. 98A, 50D, etc. In particularly preferred embodiments, the hardness of the pet chews may be in the range of 25 to 40 Shore D, including 30 to 33 Shore D. The pet chews may also exhibit an elongation at break, as measured by ASTM D638-10, in the range of 0.5% to 600% and all values therein in 1% increments, such as 1% to 7%. In addition, the tensile modulus of the pet chews, as measured by ASTM D638-10, may be in the range of 50×10³ psi to 500×10³ psi, including all values and ranges therein, such as 50×10³ psi to 300×10³ psi, in 1 psi increments. Furthermore, the flexural modulus of the pet chews may be in the range of 50×10³ psi to 500×10³ psi, as measured by ASTM D790-10, including all values and ranges therein, such as 50×10³ psi to 300×10³ psi, in 1 psi increments. An individual pet chews may exhibit one or more of the above properties, i.e., hardness, elongation at break, and tensile modulus.

Accordingly, the present invention relates to a pet chew comprising a polymer composition comprising synthetic and/or natural polymer resin(s) and Miscanthus grass, wherein the Miscanthus grass may be present at a level of 0.1% by weight to 10.0% by weight. The Miscanthus grass appears as a discontinuous phase in the polymer resin and presents as a different color relative to the color of the continuous polymeric phase. The pet chew may optionally include one or more of a flavoring, attractants, colorant, antioxidants, minerals or vitamins.

Moreover, it should be noted that any one or more of the identified optional ingredients, including flavoring, attractants, colorants, minerals or vitamins, may optionally be added to the Miscanthus grass particles, and then the Miscanthus grass particles including one or more optional ingredients, can be combined with polymer resin to form the molded product.

While particular embodiments of the present invention has been described, it should be understood that various changes, adaptations and modifications can be made therein without departing from the spirit of the invention and the scope of the appended claims. The scope of the invention should, therefore, be determined not with reference to the above description, but instead should be determined with reference to the appended claims along with their full scope of equivalents. Furthermore, it should be understood that the appended claims do not necessarily comprise the broadest scope of the invention which the Applicant is entitled to claim, or the only manner(s) in which the invention may be claimed, or that all recited features are necessary.

What is claimed:

1. A method of forming a pet chew, comprising:
supplying Miscanthus grass;
supplying at least one polymer;
combining the Miscanthus grass and the at least one polymer to form a polymeric composition containing the Miscanthus grass; and
forming the pet chew of the polymeric composition containing the Miscanthus grass.

2. The method of claim 1, wherein combining the Miscanthus grass and the at least one polymer to form the polymeric composition containing the Miscanthus grass further comprises:
randomly dispersing the Miscanthus grass in the at least one polymer to form the polymeric composition containing the Miscanthus grass.

3. The method of claim 2, wherein randomly dispersing the Miscanthus grass in the at least one polymer to form the polymeric composition containing the Miscanthus grass further comprises:
randomly dispersing particles of the Miscanthus grass in the at least one polymer to form the polymeric composition containing the Miscanthus grass.

4. The method of claim 3, wherein:
before being randomly dispersed in the at least one polymer, the particles have a length in a range of 0.25 inch to 1.0 inch, and with a diameter in a range of 0.1 inch to 0.33 inch.

5. The method of claim 3, wherein:
before being randomly dispersed in the at least one polymer, the particles have a diameter of less than 0.1 inch.

6. The method of claim 1, wherein combining the Miscanthus grass and the at least one polymer to form a polymeric composition containing the Miscanthus grass further comprises:
melting the polymer; and
mixing the Miscanthus grass with the melted polymer to form the polymeric composition containing the Miscanthus grass.

7. The method of claim 1, wherein forming the pet chew of the polymeric composition containing the Miscanthus grass further comprises:
injection molding, compression molding or extruding the pet chew of the polymeric composition containing the Miscanthus grass.

8. The method of claim 1, further comprising:
supplying at least one additive, the at least one additive comprising a flavoring, an attractant, a colorant, an antioxidant, a mineral or a vitamin;
combining the at least one additive, the Miscanthus grass and the at least one polymer to form the polymeric composition containing the Miscanthus grass.

9. The method of claim 8, wherein:
the pet chew formed of the polymeric composition comprises 0.1% by weight of the at least one additive to 2.5% by weight of the at least one additive, respectively.

10. The method of claim 1, wherein:
the pet chew formed of the polymeric composition comprises 0.1% by weight of the Miscanthus grass to 10% by weight of the Miscanthus grass.

11. The method of claim 1, wherein:
the at least one polymer comprises at least one thermoplastic polymer.

12. The method of claim 11, wherein:
the at least one thermoplastic polymer comprises a natural polymer.

13. A pet chew, comprising:
a polymeric composition comprising at least one polymer and Miscanthus grass; and
the polymeric composition molded in a form of the pet chew.

14. The pet chew of claim 13, wherein:
the Miscanthus grass is in a form of randomly dispersed particles within the polymeric composition.

15. The pet chew of claim 13, wherein:
the pet chew formed of the polymeric composition comprises 0.1% by weight of the Miscanthus grass to 10% by weight of the Miscanthus grass

16. The pet chew of claim 13, wherein:
the particles of Miscanthus grass appear as spots within the polymeric composition of the pet chew; and
the spots have a size in a range of 0.1 mm to 10.0 mm.

17. The pet chew of claim 13, wherein:
the particles of Miscanthus grass appear as spots within the polymeric composition of the pet chew; and
the spots have a darker color than the at least one polymer of the polymeric composition.

18. The pet chew of claim 13, wherein:
the at least one polymer comprises at least one thermoplastic polymer.

19. The pet chew of claim 18, wherein:
the at least one thermoplastic polymer comprises polyamide.

20. The pet chew of claim 13, wherein:
the polymer composition further comprises at least one additive, the at least one additive comprising a flavoring, an attractant, a colorant, an antioxidant, a mineral or a vitamin.
